(19) United States
(12) Patent Application Publication
(10) Pub. No.: US 2026/0238059 A1
(43) Pub. Date: Aug. 13, 2026

(54) ELECTRIC MOTOR INCLUDING HAIRPIN WINDINGS WITH ODD NUMBER OF CONDUCTOR LAYERS IN THE STATOR SLOTS

(71) Applicants: Ramon CASTILLO, Guadalajara (MX); Juan Bernardo SOSA, Guadalajara (MX); Gilberto Edgar Abraham Castro Sustaita, Cholula (MX)

(72) Inventors: Ramon CASTILLO, Guadalajara (MX); Juan Bernardo SOSA, Guadalajara (MX); Gilberto Edgar Abraham Castro Sustaita, Cholula (MX)

(21) Appl. No.: 19/049,933

(22) Filed: Feb. 10, 2025

(51) Int. Cl. H02K 3/28

(52) U.S. Cl. CPC H02K 3/28

(57) ABSTRACT

An alternating current electric motor is provided that includes a stator core defining a number of slots; and a plurality of phase sections of hairpin windings disposed in respective sets of the slots. Each of the phase sections of hairpin windings is configured for receiving a respective phase of alternating current. The hairpin windings of each phase section pass through the respective set of slots via turns. Each turn including two segments that each pass through a different respective one of the slots. The turns each have a same turn throw defining a slot separation number of the two different respective slots the turn passes through. The stator includes a number of poles. A total number of the segments in each slot defines a number of layers of the hairpin winding. The numbers of layers of hairpin windings are an odd number. The turn throw is equal to the number of the slots of the stator core divided by the number of poles of the stator. The turn throw divided by a number of the phases is an integer. The number of the poles divided by a number of parallel electrical paths for each phase section of hairpin windings is an even number.

The present disclosure relates generally to electric motors, and more specifically to heat exchangers for electric motors with hairpin windings.

### BACKGROUND

Existing hairpin windings have an even number of conductor layers in each stator slot.

### SUMMARY

An alternating current electric motor is provided that includes a stator core defining a number of slots; and a plurality of phase sections of hairpin windings disposed in respective sets of the slots. Each of the phase sections of hairpin windings is configured for receiving a respective phase of alternating current. The hairpin windings of each phase section pass through the respective set of slots via turns. Each turn including two segments that each pass through a different respective one of the slots. The turns each have a same turn throw defining a slot separation number of the two different respective slots the turn passes through. The stator includes a number of poles. A total number of the segments in each slot defines a number of layers of hairpin winding. The numbers of layers of hairpin windings are an odd number. The turn throw is equal to the number of the slots of the stator core divided by the number of poles of the stator. The turn throw divided by a number of the phases is an integer. The number of the poles divided by a number of parallel electrical paths for each phase section of hairpin windings is an even number.

In examples, some of the turns are grouped together to form groups of turns and some of the turns are ungrouped turns, each group of turns including an even number of turns and passing through a respective first slot of slots together and a respective second slot of the slots together, each of the groups of turns passing through the respective first slot with a respective first turn of ungrouped turns to form the odd number layers in the respective first slot, each of the groups of turns passing through the respective second slot with a respective second turn of the ungrouped turns to form the odd number layers in the respective second slot.

In examples, the hairpin windings of each phase include multiple sets of turns, each of the sets of turns including two subsets of turns such that the hairpin windings of each phase alternate between a first subset of turns and a second subset of turns, the first subset of turns being formed by two of the ungrouped groups turns, the second subset of turns being formed by two of the groups of turns.

In examples, an alternating current electric motor, where each of the groups of turns is formed by two turns.

In examples, the turns are grouped to form a first group of turns, a second group of turns, a third group of turns and a fourth group of turns, the slots alternating between first slots and second slots, each of the first group of turns and the second groups of turns including a same even number of turns, each of the third group of turns and the fourth groups of turns including a same odd number of turns, each of the first group of turns passing through one of the first slots together with one of the third groups of turns, and each of the first group of turns passing through another of the first slots together with another of the third groups of turns, each of the second group of turns passing through one of the second slots together with one of the fourth groups of turns, and each of the second group of turns passing through another of the second slots together with another of the fourth groups of turns.

In examples, the hairpin windings of each phase include multiple sets of turns, each of the sets of turns including two subsets of turns such that the hairpin windings of each phase alternate between a first subset of turns and a second subset of turns, the first subset of turns each being formed by one of the first group of turns and one of the second group of turns, the second subset of turns being formed by one of the third group of turns and one of the fourth group of turns.

In examples, each of the first group of turns and each of the second group of turns includes three turns, and each of the third group of turns and each of the fourth group of turns includes two turns.

In examples, one of the turns of one of the second groups of turns extends to a first terminal for the respective parallel path and one of the turns of one of the third groups of turns extends to a second terminal for the respective parallel path.

In examples, a difference between the same even number of turns and the same odd number of turns is one.

In examples, the hairpin windings of each phase include multiple sets of turns, each of the sets of turns including two subsets of turns such that the hairpin windings of each phase alternate between a first subset of turns and a second subset of turns, each the turns of the first subset passing through the respective slots with at least one of the turns of the second subset.

In examples, each of the first subsets includes a same first number of turns, and each of the second subsets includes a same second number of turns, the first number of turns being different from the second number of turns.

In examples, each of the first subsets includes a first group of turns and a second group of turns, each of the first groups including turns that pass through two of the slots together, each of the first groups including turns that pass through two of the slots together, each of the first groups and each of the second groups including a same first number of turns, wherein each of the second subsets includes a third group of turns and a fourth group of turns, each of the third groups including turns that pass through two of the slots together, each of the fourth groups including turns that pass through two of the slots together, each of the third groups and each of the fourth groups including a same second number of turns, the first number of turns being different from the second number of turns.

In examples, the first number of turns is an odd number of turns and the second number of turns is an even number of turns.

In examples, each of the first groups of turns passes through a same one of the slots as one of the third groups of turns and through a same one of the slots as another of the third groups of turns, wherein each of the second groups of turns passes through a same one of the slots as one of the fourth groups of turns and through a same one of the slots as another of the fourth groups of turns.

A method of constructing an alternating current electric motor includes installing a plurality of phase sections of hairpin windings in respective slots of a stator, each of the phase sections of hairpin windings configured for receiving a respective phase of alternating current; the hairpin windings of each phase section being installed through the respective slots via turns, each turn including two segments that each installed in a different respective one of the slots, the turns each having a same turn throw defining a slot separation number of the two different respective slots the turn passes through, that stator including a number of poles, a total number of the segments in each slot defining a number of layers of hairpin windings, the numbers of layers of hairpin windings being an odd number, the turn throw being equal to the number of the slots of the stator core divided by the number of poles of the stator, the turn throw divided by a number of the phases being an integer, the number of the poles divided by a number of parallel electrical paths for each phase section of hairpin windings being an even number.

In examples, the hairpin windings of each phase include multiple sets of turns, each of the sets of turns including two subsets of turns such that the hairpin windings of each phase alternate between a first subset of turns and a second subset of turns, each the turns of the first subset passing through the respective slots with at least one of the turns of the second subset, each of the first subsets includes a same first number of turns, and each of the second subsets includes a same second number of turns, the first number of turns being different from the second number of turns.

In examples, each of the first subsets includes a first group of turns or a first single turn and a second group of turns or a second single turn, each of the first groups including turns that pass through two of the slots together, each of the first groups including turns that pass through two of the slots together, each of the first groups and each of the second groups including a same third number of turns, wherein each of the second subsets includes a third group of turns and a fourth group of turns, each of the third groups including turns that pass through two of the slots together, each of the fourth groups including turns that pass through two of the slots together, each of the third groups and each of the fourth groups including a same fourth number of turns, the third number of turns being an odd number of turns and the fourth number of turns being an even number of turns.

In examples, each of the first groups of turns or each of the single turns passes through a same one of the slots as one of the third groups of turns and through a same one of the slots as another of the third groups of turns, wherein each of the second groups of turns or each of the single turns passes through a same one of the slots as one of the fourth groups of turns and through a same one of the slots as another of the fourth groups of turns.

### BRIEF DESCRIPTION OF THE DRAWINGS

The present disclosure is described below by reference to the following drawings, in which:

FIG. 1a schematically shows an example of a stator in accordance with the present disclosure;

FIG. 1b schematically shows two turns of the hairpin winding; and

FIG. 2 schematically shows another example of a stator in accordance with the present disclosure.

### DETAILED DESCRIPTION

Electric motors with hairpin winding use even number of conductor layers; however, when the output characteristics of these motors are being tuned it is restrictive to select only even number of conductor layers. The inventors have discovered through simulations that hairpin windings with odd number of layers with a design that achieves the electromagnetic balancing between parallel paths and phases.

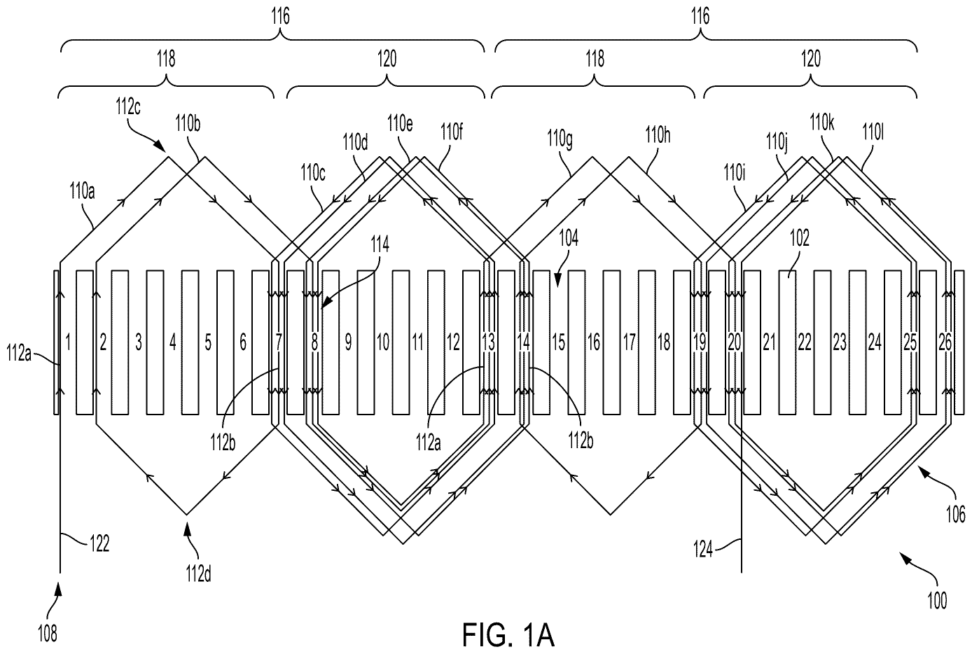

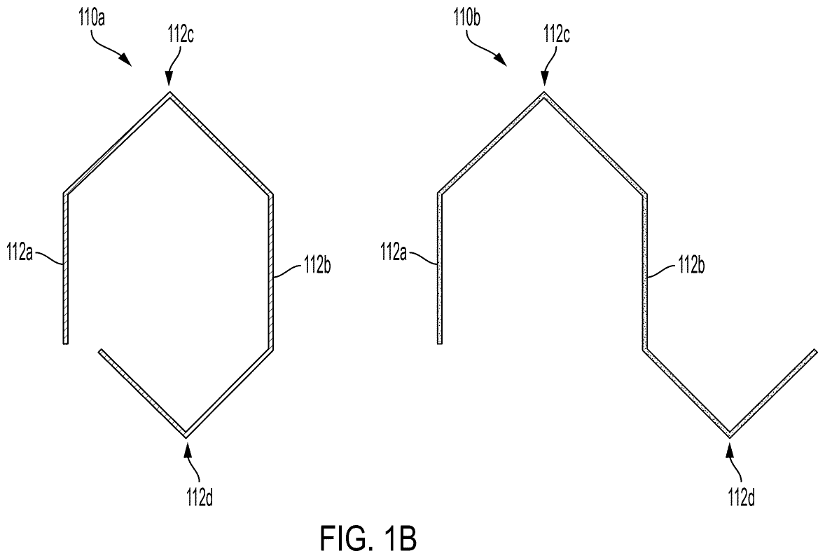

FIG. 1a schematically shows a stator 100 of a three phase alternating current electric motor that includes a stator core 102 defining a number of slots 104.

The electric motor also includes plurality of phase sections of hairpin windings 106 disposed in respective sets of the slots 104. While only a single phase section 108 is shown in FIG. 1, it should be understood that a second phase section identical to phase section 108 is present starting two slots offset to the right of phase section 108, and a third phase section identical to phase section 108 is present starting four slots offset to the right of phase section 108. Each of the phase sections of hairpin windings 106 is configured for receiving a respective phase of alternating current.

The hairpin windings 106 of each phase section pass through the respective set of slots via turns. FIG. 1b schematically illustrates two different turns 110a, 110b from FIG. 1a. While turns 110a, 110b have different shapes than each other, it is illustrated by comparing FIG. 1b with FIG. 1a that each turn 110a to 110l in FIG. 1a includes a first segment 112a that is received in one of the slots 104, a second segment 112b that is received in another of the slots 104, and an end bend 112c. A majority of the turns 110a (i.e., all except turn 110l) also includes a second end bend 112d. Turns 110a to 110l are contiguous with each other and join each other in an alphabetical order.

Referring back to FIG. 1a, all of the turns 110a to 110l each having a same turn throw defining a slot separation number of the two different respective slots the turn passes through. For example, referring to turn 110a, the first segment 112a of turn 110a is in a slot 104 numbered 1, and the second segment 112b of turn 110a is in a slot 104 numbered 7, showing that turn 110a has a turn throw of six. All of the other turns 110b to 110l also have a turn throw of six.

It should be understand that while stator core 102 is shown in FIG. 1 as a strip that represents a little greater than half of the stator core 102 (shows 26 of 48 slots) and includes a single parallel path for each phase, stator core 102 has an annular shape that includes a second identical overlapping parallel path. In particular, a second phase section identical to the phase section 108 shown in FIG. 1a would overlap both ends of phase section 108; and a turn of the second phase section identical to turn 110a would be in slot 104 numbered 25 with turns 110i, 110j; a turn of the second phase section identical to turn 110b would be in slot 104 numbered 26 turns 110k, 110l; turns of the second phase section identical to turns 110i, 110j would be in slot #1 with turn 110a; and turns of the second phase section identical to turns 110k, 110l would be in slot #2 with turn 110a. With such an arrangement, the stator 104 includes eight poles.

A total number of segments 112a or 112b in each slot defines a number of conductive layers 114 of hairpin windings in stator 104, and the numbers of conductive layers 114 of hairpin windings in each slot 104 is an odd number. This odd number of conductive layers 114 in each slot 104 is advantageous in that certain torque and power required values can be more easily met than in motors with only even numbers of conductive layers in each slot.

In order to achieve the electromagnetic balancing between parallel paths and phases, the turn throw is equal to the number of the slots of the stator core divided by the number of poles of the stator, the turn throw divided by the number of the phases is an integer, and the number of the poles divided by a number of parallel electrical paths for each phase section of hairpin windings is an even number.

In the example of FIG. 1a, some of the turns 110a to 110l are grouped together to form groups of turns and some of the turns are ungrouped turns. In particular, turns 110a, 110b, 110g, 110h are ungrouped turns, turns 110c, 110d are grouped together, turns 110e, 110f are grouped together, turns 110i, 110j are grouped together, and turns 110k, 110l are grouped together. Each group of turns includes an even number of turns and pass through a respective first slot of slots 104 together and a respective second slot of the slots 104 together. For example, turns 110c, 110d pass through the respective first slot 104 numbered 13 together and a respective second slot 104 numbered 7 together.

Each of the groups of turns passes through the respective first slot with a respective first turn of ungrouped turns to form the odd number layers in the respective first slot. For example, turns 110c, 110d pass through the respective first slot 104 numbered 13 with turn 110a to provide three conductive layers in the slot 104 numbered 13, and a through the respective second slot 104 numbered 7 with turn 110g to provide three conductive layers in the slot 104 numbered 7.

The hairpin windings of each phase include multiple sets 116 of turns, which each set including a same number of turns. Two sets 116 are shown in FIG. 1a, and because FIG. 1a shows half of the turns of the stator 100, stator 100 includes four sets 116 of turns. The left set 116 shown in FIG. 1a includes the six turns 110a to 110f, and the right set 116 shown in FIG. 1a includes the six turns 110g to 110l. Each of the sets 116 of turns including two subsets 118, 120 of turns such that the hairpin windings of each phase alternate between a first subset 118 of turns and a second subset 120. The first subset 118 of turns are each being formed by two of the ungrouped turns. The left subset 118 is formed by the ungrouped turns 110a, 110b, and the right subset 118 is formed by the ungrouped turns 110g, 110h. The second subset 120 of turns are each being formed by two of the grouped turns. The left subset 120 is formed by two groups of turns in the form of the grouped turns 110c, 110d and grouped turns 110e, 110f, and the right subset 120 is formed by two groups of turns in the form of the grouped turns 110i, 110j and grouped turns 110k, 110l. It is thus apparent that subsets 118 each includes the same number of turns and subsets 120 include the same number of turns, but subsets 118 include different numbers of turns than subsets 120. In particular, as subsets 118 each include two turns and subsets 120 each include four turns, subsets 120 each include two more turns than each subset 118. The grouped turns of subsets 120 each include one more turn than the ungrouped turns of subset 118.

End bend 110a of the parallel path shown in FIG. 1a extends to a first terminal 122 for this respective parallel path and the end bend 110l extends to a second terminal 124 for this respective parallel path.

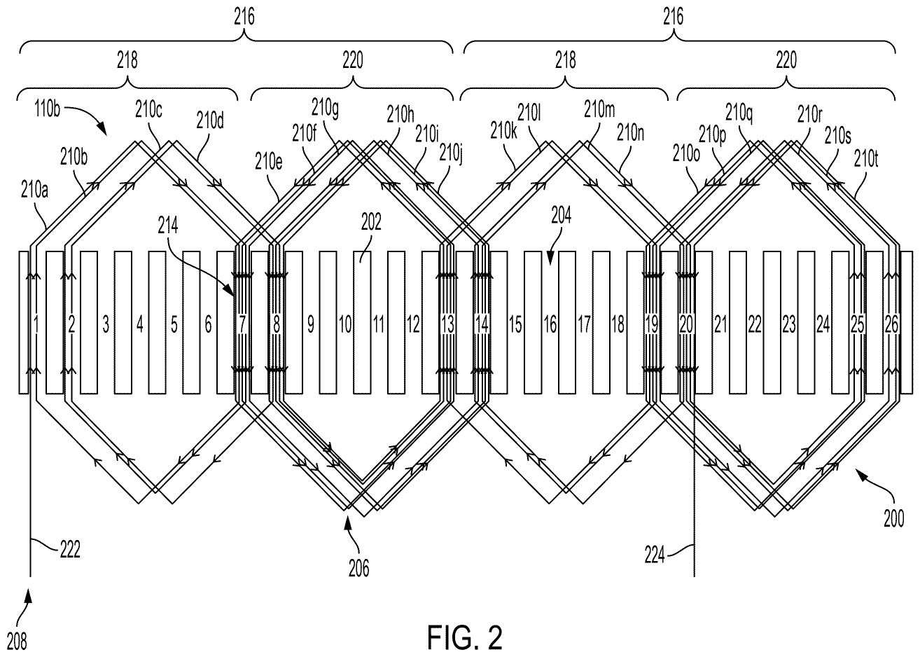

FIG. 2 schematically shows a stator 200 of a three phase alternating current electric motor that includes a stator core 202 defining a number of slots 204.

The electric motor also includes plurality of phase sections of hairpin windings 206 disposed in respective sets of the slots 204. While only a single phase section 208 is shown in FIG. 2, it should be understood that a second phase section identical to phase section 208 is present starting two slots offset to the right of phase section 208, and a third phase section identical to phase section 208 is present starting four slots offset to the right of phase section 208. Each of the phase sections of hairpin windings 206 is configured for receiving a respective phase of alternating current.

The hairpin windings 206 of each phase section pass through the respective set of slots via turns, which are discussed above with respect to FIG. 1b. Each turn 210a to 210t in FIG. 2 includes a first segment 212a that is received in one of the slots 204, a second segment 212b that is received in another of the slots 204, and an end bend 212c. A majority of the turns (i.e., all except turn 210t) also includes a second end bend 212d.

All of the turns 210a to 210t each having a same turn throw defining a slot separation number of the two different respective slots the turn passes through. For example, referring to turn 210a, the first segment 212a of turn 210a is in a slot 204 numbered 1, and the second segment 212b of turn 210a is in a slot 204 numbered 7, showing that turn 210a has a turn throw of six. All of the other turns 210b to 210t also have a turn throw of six.

It should be understand that while stator core 202 is shown in FIG. 2 as a strip that represents a little greater than half of the stator core 202 (shows 26 of 48 slots) and includes a single parallel path for each phase, stator core 202 has an annular shape that includes a second identical overlapping parallel path. In particular, a second phase section identical to the phase section 208 shown in FIG. 2 would overlap both ends of phase section 208; and turns of the second phase section identical to turns 210a, 210b would be in slot 204 numbered 25 with turns 210o to 210q; turns of the second phase section identical to turns 210c, 210d would be in slot 204 numbered 26 with turns 210r to 210t; turns of the second phase section identical to turns 210o to 210q would be in slot #1 with turns 210a, 210b; and turns of the second phase section identical to turns 210r to 210t would be in slot #2 with turns 210c, 210d. With such an arrangement, the stator 204 includes eight poles.

A total number of segments 212a or 212b in each slot defines a number of conductive layers 214 of hairpin windings in stator 204, and the numbers of conductive layers 214 of hairpin windings in each slot 204 is an odd number. This odd number of conductive layers 214 in each slot 204 is advantageous in that certain torque and power required values can be more easily met than in motors with only even numbers of conductive layers in each slot.

In order to achieve the electromagnetic balancing between parallel paths and phases, the turn throw is equal to the number of the slots of the stator core divided by the number of poles of the stator, the turn throw divided by the number of the phases is an integer, and the number of the poles divided by a number of parallel electrical paths for each phase section of hairpin windings is an even number.

The hairpin windings of each phase include multiple sets 216 of turns, which each set including a same number of turns. Two sets 216 are shown in FIG. 2, and because FIG. 2 shows half of the turns of the stator 200, stator 200 includes four sets 216 of turns. The left set 216 shown in FIG. 2 includes the ten turns 210a to 210j, and the right set 216 shown in FIG. 2 includes the ten turns 210k to 210t. Each of the sets 216 of turns including two subsets 218, 220 of turns such that the hairpin windings of each phase alternate between a first subset 218 of turns and a second subset 220. The left subset 218 is formed by two groups of turns in the form of a first group of turns 210a, 210b and a second group of turns 210c, 210d; and the right subset 218 is formed by two groups of turns in the form of a first group of turns 210k, 210l and a second group of turns 210m, 210n. The left subset 220 is formed by two groups of turns in the form of a third group of turns 210e to 210g and a fourth group of turns 210h to 210j; and the right subset 220 is formed by two groups of turns in the form of a third group of turns 210o to 210q and a fourth group of turns 210r to 210t. It is thus apparent that subsets 218 each includes the same number of turns and subsets 220 include the same number of turns, but subsets 218 include different numbers of turns than subsets 220. In particular, as subsets 218 each include four turns and subsets 220 each include six turns, subsets 220 each include two more turns than each subset 218. The first and second groups of turns of subsets 218 each include one less turn than the third and fourth groups of turns of subset 220.

Each of the first group of turns 210a, 210b and 210k, 210l and the second groups of turns 210c, 210d and 210m, 210n include a same even number of turns, which in this example is two. Each of the third group of turns 210e to 210g or 210o to 210q and the fourth groups of turns 210h to 210j and 210r to 210t include a same odd number of turns, which in this example is three. It is noted that the even and odd numbers can be different that the example shown in FIG. 2. For example, the first and second groups can include any number of even or odd turns, and the third and fourth groups can include any number of even or odd turns as long as the conductive layers in each slot is an odd number. It can be advantageous to have the difference between the number of turns of the first and second groups to vary from the number of turns of the third and groups by one.

The slots 204 alternating between first slots 204 (in this example odd numbered slots) and second slots 204 (in this example even numbered slots). Remembering that the stator 200 includes two identical parallel paths whose ends overlap, each of the first group of turns 210a, 210b and 210k, 210l passes through one of the first slots together with one of the third groups of turns 210e to 210g or 210o to 210q, and each of the first group of turns 210a, 210b and 210k, 210l passes through another of the first slots together with another of the third groups of turns 210e to 210g or 210o. For example, the first group of turns 210k, 210l passes through the slot 204 numbered 13 together with the third group of turns 210e to 210g, and passes through the slot 204 numbered 19 together with the third group of turns 210o to 210q. Similarly, each of the second groups of turns 210c, 210d and 210m, 210n passes through one of the second slots together with one of the fourth groups of turns 210h to 210j or 210r to 210t, and each of the second groups of turns 210c, 210d and 210m, 210n passes through another of the second slots together with another of the fourth groups of turns 210h to 210j or 210r to 210t. For example, the second group of turns 210m, 210n passes through the slot 204 numbered 20 together with the fourth group of turns 210r to 210t, and passes through the slot 204 numbered 14 together with the fourth group of turns 210h to 210j.

End bend 210a of the parallel path shown in FIG. 2 extends to a first terminal 222 for this respective parallel path and the end bend 210t extends to a second terminal 224 for this respective parallel path.

In the preceding specification, the present disclosure has been described with reference to specific exemplary embodiments and examples thereof. It will, however, be evident that various modifications and changes may be made thereto without departing from the broader spirit and scope of present disclosure as set forth in the claims that follow. The specification and drawings are accordingly to be regarded in an illustrative manner rather than a restrictive sense.

### LIST OF REFERENCE NUMBERS

100 stator
102 stator core
104 slot
106 hairpin windings
108 phase section
110a to 110l turns
112a first segment
112b second segment
112c end bend
112d second end bend
114 number of conductive layers
116 multiple sets
118 subsets
120 subsets
122 first terminal
124 second terminal
200 stator
202 stator core
204 slot
206 hairpin windings
208 phase section
210a to 210t turns
212a first segment
212b second segment
212c end bend
212d second end bend
214 number of conductive layers
216 multiple sets
218 subsets
220 subsets
222 first terminal
224 second terminal

What is claimed is:

1. An alternating current electric motor comprising:
a stator core defining a number of slots; and
a plurality of phase sections of hairpin windings disposed in respective sets of the slots, each of the phase sections of hairpin windings configured for receiving a respective phase of alternating current,
the hairpin windings of each phase section passing through the respective set of slots via turns, each turn including two segments that each pass through a different respective one of the slots, the turns each having a same turn throw defining a slot separation number of the two different respective slots the turn passes through,
the stator including a number of poles,
a total number of the segments in each slot defining a number of layers of hairpin windings, the numbers of layers of hairpin windings being an odd number,
the turn throw being equal to the number of the slots of the stator core divided by the number of poles of the stator,
the turn throw divided by a number of the phases being an integer,
the number of the poles divided by a number of parallel electrical paths for each phase section of hairpin windings being an even number.

2. The alternating current electric motor as recited in claim 1, wherein some of the turns are grouped together to form groups of turns and some of the turns are ungrouped turns, each group of turns including an even number of turns and passing through a respective first slot of slots together and a respective second slot of the slots together,
each of the groups of turns passing through the respective first slot with a respective first turn of ungrouped turns to form the odd number layers in the respective first slot,
each of the groups of turns passing through the respective second slot with a respective second turn of the ungrouped turns to form the odd number layers in the respective second slot.

3. The alternating current electric motor as recited in claim 2, wherein the hairpin windings of each phase include multiple sets of turns,
each of the sets of turns including two subsets of turns such that the hairpin windings of each phase alternate between a first subset of turns and a second subset of turns,
the first subset of turns being formed by two of the ungrouped groups turns,
the second subset of turns being formed by two of the groups of turns.

4. The alternating current electric motor as recited in claim 3, where each of the groups of turns is formed by two turns.

5. The alternating current electric motor as recited in claim 1, wherein the turns are grouped to form a first group of turns, a second group of turns, a third group of turns and a fourth group of turns,
the slots alternating between first slots and second slots,
each of the first group of turns and the second groups of turns including a same even number of turns,
each of the third group of turns and the fourth groups of turns including a same odd number of turns,
each of the first group of turns passing through one of the first slots together with one of the third groups of turns, and each of the first group of turns passing through another of the first slots together with another of the third groups of turns,
each of the second group of turns passing through one of the second slots together with one of the fourth groups of turns, and each of the second group of turns passing through another of the second slots together with another of the fourth groups of turns.

6. The alternating current electric motor as recited in claim 5, wherein the hairpin windings of each phase include multiple sets of turns,
each of the sets of turns including two subsets of turns such that the hairpin windings of each phase alternate between a first subset of turns and a second subset of turns,
the first subset of turns each being formed by one of the first group of turns and one of the second group of turns,
the second subset of turns being formed by one of the third group of turns and one of the fourth group of turns.

7. The alternating current electric motor as recited in claim 6, wherein each of the first group of turns and each of the second group of turns includes three turns, and
each of the third group of turns and each of the fourth group of turns includes two turns.

8. The alternating current electric motor as recited in claim 5, wherein one of the turns of one of the second groups of turns extends to a first terminal for the respective parallel path and one of the turns of one of the third groups of turns extends to a second terminal for the respective parallel path.

9. The alternating current electric motor as recited in claim 5, wherein a difference between the same even number of turns and the same odd number of turns is one.

10. The alternating current electric motor as recited in claim 1, wherein the hairpin windings of each phase include multiple sets of turns,
each of the sets of turns including two subsets of turns such that the hairpin windings of each phase alternate between a first subset of turns and a second subset of turns,
each the turns of the first subset passing through the respective slots with at least one of the turns of the second subset.

11. The alternating current electric motor as recited in claim 10, wherein each of the first subsets includes a same first number of turns, and each of the second subsets includes a same second number of turns,
the first number of turns being different from the second number of turns.

12. The alternating current electric motor as recited in claim 10, wherein each of the first subsets includes a first group of turns and a second group of turns,
each of the first groups including turns that pass through two of the slots together, each of the first groups including turns that pass through two of the slots together,
each of the first groups and each of the second groups including a same first number of turns,
wherein each of the second subsets includes a third group of turns and a fourth group of turns,
each of the third groups including turns that pass through two of the slots together, each of the fourth groups including turns that pass through two of the slots together,
each of the third groups and each of the fourth groups including a same second number of turns,
the first number of turns being different from the second number of turns.

13. The alternating current electric motor as recited in claim 12, wherein the first number of turns is an odd number of turns and the second number of turns is an even number of turns.

14. The alternating current electric motor as recited in claim 12, wherein each of the first groups of turns passes through a same one of the slots as one of the third groups of turns and through a same one of the slots as another of the third groups of turns,
wherein each of the second groups of turns passes through a same one of the slots as one of the fourth groups of turns and through a same one of the slots as another of the fourth groups of turns.

15. A method of constructing an alternating current electric motor, the method comprising:
installing a plurality of phase sections of hairpin windings in respective slots of a stator, each of the phase sections of hairpin windings configured for receiving a respective phase of alternating current;
the hairpin windings of each phase section being installed through the respective slots via turns, each turn including two segments that each installed in a different respective one of the slots, the turns each having a same turn throw defining a slot separation number of the two different respective slots the turn passes through,
that stator including a number of poles,
a total number of the segments in each slot defining a number of layers of hairpin windings, the numbers of layers of hairpin windings being an odd number,
the turn throw being equal to the number of the slots of the stator divided by the number of poles of the stator,
the turn throw divided by a number of the phases being an integer,
the number of the poles divided by a number of parallel electrical paths for each phase section of hairpin windings being an even number.

16. The method as cited in claim 15, wherein the hairpin windings of each phase include multiple sets of turns,
each of the sets of turns including two subsets of turns such that the hairpin windings of each phase alternate between a first subset of turns and a second subset of turns,
each the turns of the first subset passing through the respective slots with at least one of the turns of the second subset,
each of the first subsets includes a same first number of turns, and each of the second subsets includes a same second number of turns,
the first number of turns being different from the second number of turns.

17. The method as cited in claim 16, wherein each of the first subsets includes a first group of turns or a first single turn and a second group of turns or a second single turn,
each of the first groups including turns that pass through two of the slots together, each of the first groups including turns that pass through two of the slots together,
each of the first groups and each of the second groups including a same third number of turns,
wherein each of the second subsets includes a third group of turns and a fourth group of turns,
each of the third groups including turns that pass through two of the slots together, each of the fourth groups including turns that pass through two of the slots together,
each of the third groups and each of the fourth groups including a same fourth number of turns,
the third number of turns being an odd number of turns and the fourth number of turns being an even number of turns.

18. The method as recited in claim 17, wherein each of the first groups of turns or each of the single turns passes through a same one of the slots as one of the third groups of turns and through a same one of the slots as another of the third groups of turns,
wherein each of the second groups of turns or each of the single turns passes through a same one of the slots as one of the fourth groups of turns and through a same one of the slots as another of the fourth groups of turns.
